(19) United States
(12) Patent Application Publication
(10) Pub. No.: US 2018/0079942 A1
(43) Pub. Date: Mar. 22, 2018

(54) REFRIGERANT BLEND OF R-744 and R-1234yf FOR USE IN STATIONARY OR MOBILE AIR CONDITIONING SYSTEMS USING PAG, POE OR PVE LUBE OIL

(71) Applicant: FORD GLOBAL TECHNOLOGIES, LLC, Dearborn, MI (US)

(72) Inventors: Edward Stanley Sakowicz, Dearborn Heights, MI (US); Angelo Patti, Pleasant Ridge, MI (US)

(21) Appl. No.: 15/269,499

(22) Filed: Sep. 19, 2016

(51) Int. Cl. C09K 5/04; C10M 171/00; C10M 107/24; C10M 107/34; C10M 105/38; F25B 31/00; F25B 9/00

(52) U.S. Cl. CPC C09K 5/045; C10M 171/008; C10M 107/24; C10M 107/34; C10M 105/38; F25B 31/002; F25B 2400/121; C09K 2205/126; C09K 2205/106; C10M 2209/043; C10M 2209/1033; C10M 2207/2835; F25B 9/008

(57) ABSTRACT

A refrigerant composition of R-1234yf and R-744 is disclosed. In some embodiments, the R-744 is 5% or less by weight of the composition. In instances where PVE is utilized as a lubricant with the refrigerant, R-744 may be 50% or less of the composition. Systems utilizing the refrigerant and methods of using such are also disclosed.

### TECHNICAL FIELD

This document relates generally to a refrigerant composition for heat transfer in cooling systems, such as air-conditioners and heat pumps.

### BACKGROUND

Concern respecting the environmental impact over refrigerants has spurred research for alternatives that function equivalently but with lower impact. A refrigerant functions in a heat transfer system through evaporation from a liquid form at low pressure, which requires surrounding heat energy. In such systems, the evaporated refrigerant is compressed and moved from a first zone to withdraw heat within the zone and then condensed back to a liquid form in a second zone where it also releases the heat energy. The liquid refrigerant can recycle through the system and effectively transfer heat to the second zone. Efficacy with selection of a refrigerant lies in how well it can perform within such a system.

Refrigerants relied on in the past have revealed themselves to be environmentally harmful causing industry to adapt standards respecting a refrigerant's ozone depletion potential and greenhouse warming potential. Further, some refrigerant compounds are volatile and extremely flammable, rendering them unfit for consumer use. Thus, there is a continuing need to identify refrigerants that are safe, effective and up to industry standards.

### SUMMARY

In accordance with the purposes and benefits described herein, this document relates to the ability to use a less flammable refrigerant blend with a single or blended lubricating oil compatible with various technologies of compressor pumps used in gasoline, diesel, hybrid or electric driven vehicles.

The refrigerant composition comprises at least 95% R-1234yf and 5% or less R-744. In some embodiments, the refrigerant composition consists essentially of at least 95% R-1234yf and 5% or less R-744. In other embodiments R-1234yf may comprise at least 96, 97, 98, 99 or 99.5% of the composition. R-744 may comprise 0.5, 1, 2, 3, 4 or 5% of the composition.

In other aspects, the refrigerant and a lubricant may comprise a composition for an air conditioning unit. The lubricant may be selected from the group consisting of poly alkylene glycol, poly vinyl ether and polyol ester oil. Such compositions may be utilized in a heat transfer device.

The present invention further provides methods for cooling a space by operating a heat transfer device within the space, wherein the heat transfer device utilizes the new and improved refrigerant to transfer heat from the space.

In other embodiments, the refrigerant with poly vinyl ether allows for up to 50% R-744. The present invention accordingly provides a composition for an air conditioning unit comprising PVE and a refrigerant composition comprising R-1234yf and about 50% or less R-744. Such refrigerant compositions may consist essentially of R-744 and R-1234yf.

### DETAILED DESCRIPTION

Refrigerant identification has largely focused on identifying single compounds. This document has identified a refrigerant composition that blends refrigerant compounds, such that the final product balances the need for efficient cooling with consumer safety and environmental impact.

The refrigerant composition is comprised of a mixture R-1234yf and R-744. The refrigerant R-1234yf (2,3,3,3 tetrafluoropropene) is a relatively newly identified effective coolant with a greenhouse warming potential (GWP) of 4<1. R-1234yf is flammable, although the characteristics of this allow it to be acceptable for many applications.

Conversely, carbon dioxide (R-744 or CO₂) has a low GWP of 1, but its use in conventional systems is limited due to the high pressure it can exert within traditional R-134a-based systems. Further, use of carbon dioxide as a refrigerant is limited by its evaporation temperature, as it can allow the evaporator to become too cold forming ice from the condensed water recovered from the atmosphere. Further, carbon dioxide can provide an unfavorable temperature glide (total temperature difference between evaporation and condensation as the refrigerant is progressively vaporized/condensed). As a result it is difficult to effectively utilize R-744 without major adjustments to the refrigeration system itself, unless the amount of carbon dioxide (R-744 or CO₂) is limited so as not to strain the standard automotive air conditioning system.

The applicants have discovered that the addition of low levels of carbon dioxide mixed with R-1234yf provide a low GWP, low flammability, and efficient refrigerant composition. As known in the art, fluorocarbon combustion chemistry is largely unpredictable and it is not readily apparent that mixing a non-flammable compound with a flammable fluorocarbon will reduce the overall flammability or reduce the range of flammable compositions in air (flammability may be determined in accordance with American Society of Heating, Refrigerating and Air-Conditioning Engineers (ASHRAE) standards). Further, the applicants have identified that the incorporation of relatively low levels of R-744 in the compositions described herein, provide improved flame retardant properties to R-1234yf without loss to the cooling efficiency greater than the percentage of added minority refrigerant. The low levels of R-744 further provide efficient cooling without significant increase in pressure.

The combining of the two refrigerants at particular ratios provides an effective coolant that has lower flammability. The compositions further provide improved energy efficiency and lower pressure drop characteristics in comparison to R-1234yf alone.

The refrigerant composition may contain between 99.9% to 95% R-1234yf and 0.1% to 5% R-744 (all % amounts mentioned in compositions herein, including in the claims, are by weight based on the total weight of the compositions, unless otherwise stated). In some embodiments, the refrigerant composition contains only R-1234yf and R-744. R-1234yf may comprise 99.9, 99.8, 99.7, 99.6, 99.5, 99.4, 99.3, 99.2, 99.1, 99.0, 98.9, 98.8, 98.7, 98.6, 98.5, 98.4, 98.3, 98.2, 98.1, 98.0, 97.9, 97.8, 97.7, 97.6, 97.5, 97.4, 97.3, 97.2, 97.1, 97.0, 96.9, 96.8, 96.7, 96.7, 96.6, 96.5, 96.4, 96.3, 96.2, 96.1, 96.0, 95.9, 95.8, 95.7, 95.6, 95.5, 95.4, 95.3, 95.2, 95.1, 95.0 percent of a refrigerant composition. R-744 may comprise the remaining percentage of the refrigerant composition. R-744 may comprise 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9 or 5.0 percent of the refrigerant composition. The refrigerant composition may consist essentially of R-1234yf and R-744.

Also provided is a composition for use in cooling systems comprised of the refrigerant composition and a lubricant. The lubricant may be selected from poly alkylene glycol (PAG), poly vinyl ether (PVE) or polyol ester oil (POE) or any blend of these lubricating oils. Lubricant can affect the performance of the refrigerant utilized, particularly with respect to miscibility and solubility of the refrigerant with the lubricant utilized. The lubricant selected may comprise branched or straight chained alkyl groups. The lubricant may further comprise butylated hydroxyl toluene (BHT). The lubricant may further comprise a stabilizer, such as a diene-based compound(s), phosphates, phenol compounds and epoxides, and mixtures thereof.

The composition may further comprise PVE and a refrigerant composition. The presence of PVE as a lubricant has an unexpected benefit in that it allows for an increased presence of R-744, up to around 50%, but not exceeding 99.9% when mixed with R-1234yf.

In accordance with an additional aspect, a refrigeration working fluid may comprise about 5 to 55 parts by weight of the lubricant and about 95 to 45 parts by weight of the refrigerant composition. The lubricant may be present at 10 to 35 parts by weight. The refrigerant may be present at 90 to 65 parts by weight. The lubricant and the refrigerant should be combined such that they remain miscible at working temperatures for the system utilized. Across the temperature range to be utilized, a cloudy appearance, the formation of floc or precipitate, or separation into two distinct liquid layers indicates that the two are immiscible.

In accordance with yet another aspect, a flame retardant may be added to the refrigerant working fluid. Such additives are known in the art and include, for example: tri-(2-chloroethyl)-phosphate, (chloropropyl)phosphate, tri-(2,3-dibromopropyl)-phosphate, tri-(1,3-dichloropropyl)-phosphate, diammonium phosphate, various halogenated aromatic compounds, antimony oxide, aluminium trihydrate, polyvinyl chloride, a fluorinated iodocarbon, a fluorinated bromocarbon, trifluoro iodomethane, perfluoroalkyl amines, bromo-fluoroalkyl amines and mixtures thereof.

Still further, a heat transfer device, which incorporates the novel refrigerant composition or working fluid, is provided. Such heat transfer devices include, for example: motor vehicle air conditioning systems, residential and commercial air conditioning systems, residential and commercial refrigerator systems, residential and commercial freezer systems, chiller air conditioning systems, chiller refrigeration systems, and heat pump systems. Preferably, the heat transfer device is a refrigeration device or an air-conditioning system. Heat transfer devices may contain a centrifugal-type compressor.

The refrigerant composition and/or the refrigerant working fluid may further be provided as a blowing agent or as a foamable composition (i.e. capable of forming foam) along with known foaming agents, such as polyurethanes, polystyrene, epoxy resins or other thermoplastic polymers and resins. The compositions of the invention may be provided as a sprayable composition and combined with a propellant.

In addition, new and improved methods are provided for cooling an object or a space comprising evaporating the refrigerant composition in the space to be cooled or in the vicinity of the object to be cooled and then condensing the refrigerant composition in a space remote to the object or space.

The new and novel compositions disclosed herein may be utilized in heat transfer systems that utilize a different refrigerant. Such methods for retrofitting comprise removing an existing heat transfer fluid and introducing the compositions described herein.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled. All patent and non-patent literature cited herein is incorporated by reference in their entirety.

What is claimed:

1. A refrigerant composition comprising at least 95% R-1234yf and 5% or less R-744.

2. The refrigerant composition of claim 1, wherein the refrigerant composition consists essentially of at least 95% R-1234yf and 5% or less R-744.

3. The refrigerant composition of claim 1, wherein R-1234yf is at least 96% of the refrigerant composition.

4. The refrigerant composition of claim 3, wherein R-744 is less than 4% of the refrigerant composition.

5. The refrigerant composition of claim 1, wherein R-1234yf is at least 97% of the refrigerant composition.

6. The refrigerant composition of claim 5, wherein R-744 is less than 3% of the refrigerant composition.

7. The refrigerant composition of claim 1, wherein R-1234yf is at least 98% of the refrigerant composition.

8. The refrigerant composition of claim 7, wherein R-744 is less than 2% of the refrigerant composition.

9. The refrigerant composition of claim 1, wherein R-1234yf is at least 99% of the refrigerant composition.

10. The refrigerant composition of claim 1, wherein R-744 is less than 1% of the refrigerant composition.

11. The refrigerant composition of claim 1, wherein R-1234yf is at least 99.5% of the refrigerant composition.

12. The refrigerant composition of claim 11, wherein R-744 is less than 0.5% of the refrigerant composition.

13. A composition for an air conditioning unit comprising the refrigerant composition of claim 1 and a lubricant.

14. The composition of claim 13, wherein the lubricant is selected from the group consisting of poly alkylene glycol, poly vinyl ether and polyol ester oil.

15. A heat transfer device incorporating the composition of claim 13.

16. A method for cooling a space comprising operating a heat transfer device within the space, wherein the heat transfer device utilizes the composition of claim 8 to transfer heat from the space.

17. A composition for an air conditioning unit comprising PVE and a refrigerant composition comprising R-1234yf and about 50% or less R-744.

18. The composition of claim 17, wherein the refrigerant composition consists essentially of R-744 and R-1234yf.

19. The composition of claim 18, wherein the refrigerant composition is about 5% or less R-744.

20. A heat transfer device comprising the refrigerant composition of claim 17.
